(19) United States
(12) Patent Application Publication
(10) Pub. No.: US 2015/0166097 A1
(43) Pub. Date: Jun. 18, 2015

(54) Device for Pressing a Gear Rack Against a Pinion

(71) Applicant: TRW Automotive GmbH, Alfdorf (DE)

(72) Inventor: Markus Lingemann, Bochum (DE)

(73) Assignee: TRW Automotive GmbH, Alfdorf (DE)

(21) Appl. No.: 14/414,519

(22) PCT Filed: Jul. 10, 2013
(86) PCT No.: PCT/EP2013/064608

§ 371 Date: Jan. 13, 2015

(30) Foreign Application Priority Data
Jul. 13, 2012 (DE) 10 2012 013 964.0

(51) Int. Cl. B62D 3/12; F16H 55/28

(52) U.S. Cl. CPC B62D 3/123; F16H 55/283

(57) ABSTRACT

A device for pressing a rack against a pinion comprises a housing, a thrust piece which is shiftably guided in the housing along a pressing axis, a bearing element which can axially be fixed at the housing, and radially pressurized wedge members which each rest on the thrust piece and on the bearing element and axially urge the thrust piece away from the bearing element. A truncated coned is formed at least on one of the thrust piece on a side facing the bearing element and the bearing element on a side facing the thrust piece. At least three wedge members are provided which are uniformly distributed in a circumferential direction.

### CROSS-REFERENCE TO RELATED APPLICATIONS

This application is a national stage of International Application No. PCT/EP2013/064608 filed Jul. 10, 2013, the disclosures of which are incorporated herein by reference in entirety, and which claimed priority to German Patent Application No. 10 2012 013 964.0 filed Jul. 13, 2012, the disclosures of which are incorporated herein by reference in entirety.

### BACKGROUND OF THE INVENTION

This invention relates to a device for pressing a rack against a pinion, in particular for use in a steering gear for a vehicle.

Rack-and-pinion steering systems for vehicles are known from the prior art in various configurations. Due to their operating principle, all rack-and-pinion steering systems include a steering gear with a rack and a pinion, wherein the pinion meshes with a toothed region of the rack. A rotational force applied onto the steering shaft and the pinion via the steering wheel is converted into a rack normal force and passed on to steerable wheels of a vehicle. Usually, rack-and-pinion steering systems nowadays are formed as hydraulic, electrohydraulic or electric power-assisted steering systems which assist a vehicle operator in the steering operation.

Since considerable forces occasionally occur in the steering gear, it has already been recognized quite early that particular measures must be taken for keeping the rack in engagement with the pinion with as little backlash as possible. Otherwise, there is a risk that under load the rack moves away from the pinion by being deformed transversely to the longitudinal direction of the rack. There would at least occur an undesired increase of the backlash in the steering system, in the extreme case even slipping through of the steering system.

In order to prevent this, a thrust piece usually is employed in the region of the pinion, which urges the rack against the pinion with a rather constant pressing force. Adjusting the desired pressing force, taking account of wear phenomena as a result of the sliding friction between thrust piece and rack, which occurs during the steering operation, and avoiding disturbing rattling noise during the vehicle operation constitute the greatest challenges for pressing devices for rack-and-pinion steering systems.

U.S. Pat. No. 7,654,166 B2 already describes a pressing device for rack-and-pinion steering systems, which in operation of the vehicle operates largely free from backlash and hence particularly quietly and in addition allows an adjustment of the pressing force of the thrust piece. For pressing the rack against the pinion, this document shows a device which comprises a housing, a thrust piece which is shiftably guided in the housing along a pressing axis, a bearing element which can axially be fixed at the housing, and radially pressurized wedge members which each rest on the thrust piece and on the bearing element and axially urge the thrust piece away from the bearing element.

To keep the pressing device largely free from backlash, two separate wedge members are provided, but the assembly of the device, in particular the radial alignment and centering of the wedge members relative to the thrust piece, as well as the exact pressurization of the thrust piece in axial direction via the two inclined wedge surfaces turns out to be expensive. An off-center or not exactly axially aligned pressurization of the thrust piece can lead to jamming of the pressing device and hence to an undesired “jerking” of the steering wheel during the steering operation.

### BRIEF SUMMARY OF THE INVENTION

It is a feature of the invention to create a pressing device which with particularly little assembly effort ensures an exact and uniform pressurization of the thrust piece in axial direction.

For solving this feature, the invention provides a device for pressing a rack against a pinion comprises a housing, a thrust piece which is shiftably guided in the housing along a pressing axis, a bearing element which can axially be fixed at the housing, and radially pressurized wedge members which each rest on the thrust piece and on the bearing element and axially urge the thrust piece away from the bearing element. A truncated coned is formed at least on one of the thrust piece on a side facing the bearing element and the bearing element on a side facing the thrust piece. At least three wedge members are provided which are uniformly distributed in a circumferential direction. As a result of the frustoconical formation of the thrust piece and/or the bearing element at an axial end and of the at least three uniformly distributed wedge members, the wedge members are radially centered with respect to the pressing axis. The thrust piece on the one hand is reliably centered in radial direction towards the pressing axis, wherein the radial force components cancel each other out in the centered position, and on the other hand is uniformly urged against the rack in axial direction. The frustoconical side in particular is formed as “straight” truncated cone, i.e. as truncated cone in which the base area and the top area are arranged in parallel and concentrically.

Preferably, the wedge members of the pressing device are made of plastics. Since the occurring loads can easily be absorbed by choosing a suitable plastic material, the plastic version offers advantages with respect to weight, manufacturing costs and adaptable shape.

In one embodiment of the device for pressing a rack against a pinion, the wedge members are movable relative to each other and preferably connected with each other by flexible coupling elements. Due to the connection of the wedge members, the number of individual components is reduced and the assembly effort for the pressing device is reduced considerably.

In this embodiment, in particular two wedge members adjacent in circumferential direction can each be connected by a flexible coupling element. This represents a simple possibility for positioning all wedge members relative to each other and yet maintain an individual, radial movability.

Particularly preferably, the wedge members are designed integrally with the coupling elements and form a wedge member unit. This wedge member unit in particular can be fabricated of plastics with little expenditure and in addition requires no preassembly in which individual wedge members must be connected with each other via separate coupling elements.

In another embodiment of the pressing device, an element elastic in axial direction, in particular a disk spring or a rubber plate, is provided axially between the bearing element and the thrust piece. In this way, for example manufacturing tolerances in the components of the rack-and-pinion steering system can be compensated without a movement of the rack being undesirably impeded by the thrust piece during a steering maneuver.

In addition, there is preferably provided a spring element which radially pressurizes the wedge members with respect to the pressing axis. By this spring element, the self-centering of the thrust piece with respect to the pressing axis can easily be realized on the one hand, and on the other hand the occurring thrust piece wear can be compensated by radially shifting the wedge members.

For example, the spring element can surround, in particular enclose the wedge members and urge the same radially to the inside, i.e. towards each other. This provides for an easy manufacture of the wedge members or the wedge member unit and for an uncomplicated assembly of the spring element on the wedge members.

In a special design variant the spring element axially protrudes beyond the wedge members, is formed axially elastic and axially rests on the bearing element. The spring element, preferably an O-ring made of rubber or a similar elastic material, hence ensures both a radial pressurization of the wedge members and a backlash-free axial elasticity within the pressing device.

In a further embodiment of the pressing device, the wedge members flare in axial direction in a wedge-shaped manner, as seen radially from the inside to the outside. To reduce the surface pressures, the wedge members also can flare in circumferential direction, as seen radially from the inside to the outside, and form segment-shaped wedge members.

The invention moreover also comprises a rack-and-pinion steering system for motor vehicles, comprising a housing, a rack shiftably mounted in the housing, a pinion which engages into the rack, and an above-described device which urges the rack against the pinion.

Other advantages of this invention will become apparent to those skilled in the art from the following detailed description of the preferred embodiments, when read in light of the accompanying drawings.

### BRIEF DESCRIPTION OF THE DRAWINGS

FIG. 1 shows a detail section through a rack-and-pinion steering system with an inventive pressing device in the assembled state;

FIG. 2 shows a detail section through a rack-and-pinion steering system with an inventive pressing device in the state of use;

FIG. 3 shows a section A-A through the pressing device according to FIG. 2 at the beginning of the useful life time;

FIG. 4 shows a section A-A through the pressing device according to FIG. 2 towards the end of the useful life time;

FIG. 5 shows a detail section of the rack-and-pinion steering system of FIG. 2 with an inventive pressing device according to an alternative embodiment;

FIG. 6 shows a detail section of the rack-and-pinion steering system of FIG. 1 with an inventive pressing device according to a further alternative embodiment;

FIG. 7 shows a detail section of the rack-and-pinion steering system of FIG. 2 with an inventive pressing device according to a further alternative embodiment;

FIG. 8 shows a detail section of the rack-and-pinion steering system of FIG. 7 with an inventive pressing device according to a further alternative embodiment;

FIG. 9 shows a section A-A through the pressing device according to FIGS. 7 and 8 at the beginning of the useful life time; and

FIG. 10 shows a section A-A through the pressing device according to FIGS. 7 and 8 towards the end of the useful life time.

### DETAILED DESCRIPTION OF THE INVENTION

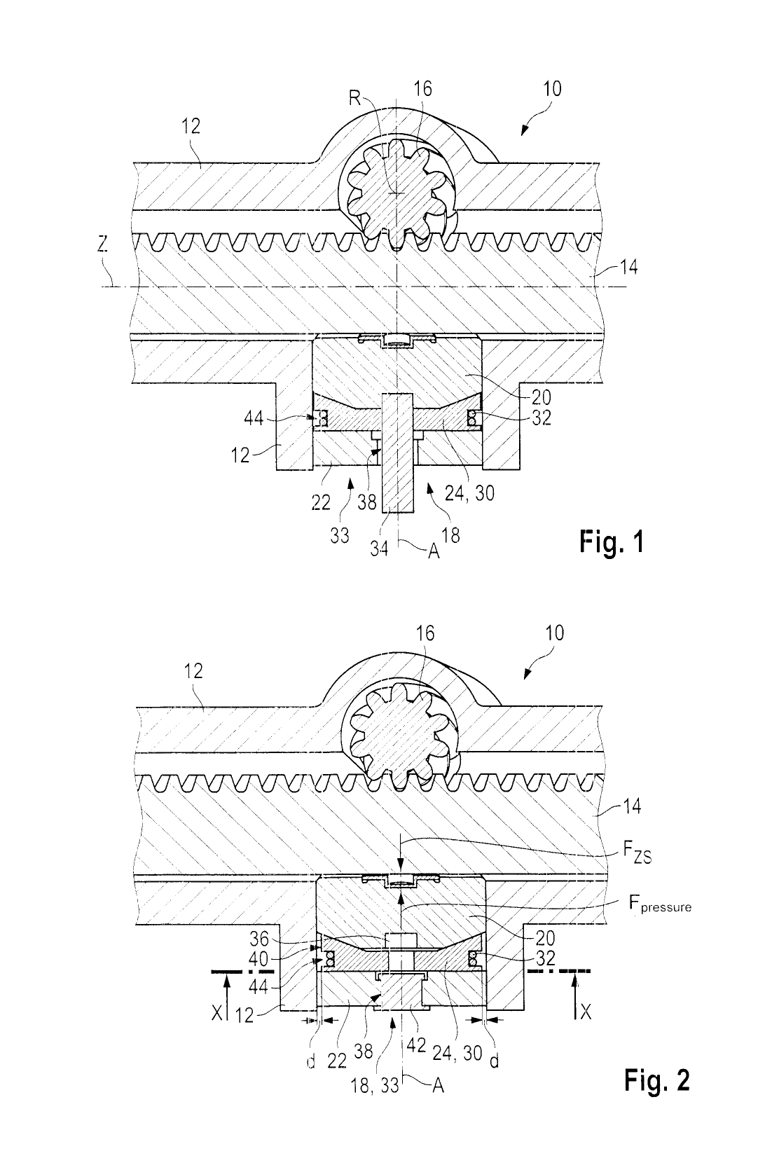

FIGS. 1 and 2 show a section of a rack-and-pinion steering system 10 for motor vehicles, comprising a housing 12, a rack 14 longitudinally shiftably mounted in the housing 12, a pinion 16 which engages into the rack 14, and a pressing device 18 which urges the rack 14 against the pinion 16. The pressing device 18 according to FIG. 1 is shown in an assembled state and according to FIG. 2 in a state of use.

In the present case, the housing 12 of the pressing device 18 is designed integrally with the housing 12 of the rack-and-pinion steering system 10. Alternatively, however, the pressing device 18 also can include a separate housing which then is attached to a housing of the rack-and-pinion steering system 10.

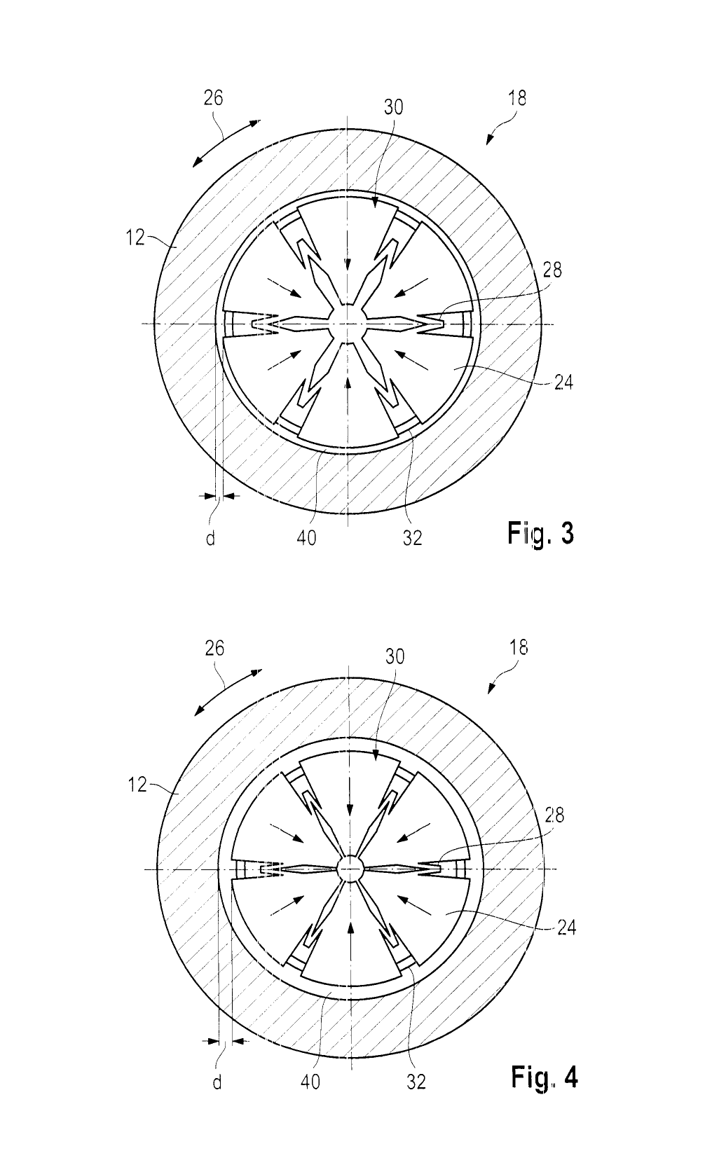

The device 18 for pressing the rack 14 against the pinion 16 comprises the housing 12, a thrust piece 20 which is shiftably guided in the housing 12 along a pressing axis A, a bearing element 22 which can axially be fixed at the housing 12, as well as radially pressurized wedge members 24 which each rest on the thrust piece 20 and on the bearing element 22 and axially urge the thrust piece 20 away from the bearing element 22 in direction of the rack 14. On a side facing the bearing element 22 the thrust piece 20 is formed as truncated cone, concretely as “straight” truncated cone, in which the circular base area is arranged in parallel and concentrically relative to the circular top area. The wedge members 24 rest against a shell surface of the frustoconical thrust piece portion, wherein in the present exemplary embodiment there are provided six wedge members 24 uniformly distributed in circumferential direction 26 (cf. FIGS. 3 and 4).

The pressing axis A in essence extends vertically, i.e. radially to a rack axis Z. In addition, the pinion 16 and the thrust piece 20 are arranged on opposite sides of the rack 14 such that an axis of rotation R of the pinion 16 and the pressing axis A of the pressing device 18 intersect each other. In alternative embodiments, however, the pressing axis A and the rack axis Z also can be offset to each other.

FIGS. 3 and 4 each show a section A-A through the pressing device 18 according to FIG. 2. It can clearly be seen that the individual wedge members 24 are connected with each other by flexible coupling elements 28, but nevertheless are movable relative to each other. Concretely, the coupling elements 28 each connect two wedge members 24 adjacent in circumferential direction 26.

In the present case, the wedge members 24 and the coupling elements 28 are made of plastics and formed integrally as wedge member unit 30.

This integrally formed wedge member unit 30 considerably simplifies the assembly of the pressing device 18, since the wedge members 24 need not be positioned individually in the housing 12.

The pressing device 18 furthermore comprises a spring element 32 which urges the wedge members 24 radially to the inside with respect to the pressing axis A. In the exemplary embodiment according to FIGS. 1 to 4, the spring element 32 is a circlip made of metal, in particular spring steel, which has two windings and encloses the wedge members 24.

The circlip can of course also be formed as C-spring. However, in order to durably provide a large enough and largely constant radial force, there are preferably used circlips with two or more windings. As an alternative to a circlip, there can also be used a hose spring.

With reference to FIGS. 1 to 4, the mode of operation and the advantages of the illustrated pressing device 18 will be described below:

In the assembled state of the pressing device 18 according to FIG. 1, the thrust piece 20 and the wedge members 24 or the wedge member unit 30 are arranged in an opening 33 of the housing 12, wherein at least the thrust piece 20 is accommodated in the housing opening 33 with a precise fit, but axially shiftably in radial direction with respect to the pressing axis A.

During insertion of the wedge member unit 30, the spring element 32 already is mounted and urges the wedge members 24 radially to the inside. To initially prevent, however, a radial displacement of the individual wedge members 24 during assembly of the pressing device 18, an assembly pin 34 is provided, which extends axially through the wedge member unit 30, so that the wedge members 24 radially rest on the assembly pin 34.

The assembly pin 34 also extends into a recess 36 of the otherwise frustoconical end face of the thrust piece 20 and thereby ensures an arrangement of the thrust piece 20 and the wedge member unit 30 which in the assembled state is concentric with respect to the pressing axis A.

Finally, the bearing element 22 is inserted into the housing opening 33 and axially fixed at the housing 12. Optionally, the bearing element 22 can be fixed such that it already exerts a certain axial pretension, so that the rack 14 is forced against the pinion 16 via the wedge member unit 30 and the thrust piece 20.

In the illustrated exemplary embodiment, the bearing element 22 is a bearing cap, wherein an external thread of the bearing cap engages into an internal thread of the housing opening 33, in order to axially fix the bearing element 22 at the housing 12. A desired axial positioning is easily adjustable in this case.

According to FIG. 1, the bearing element 22 includes an assembly opening 38 through which the assembly pin 34 extends axially to outside of the housing 12. Finally, the assembly pin 34 is axially withdrawn from the pressing device 18 via the assembly opening 38, in order to activate the pressing device 18, i.e. transfer the same from the assembled state into its state of use according to FIG. 2.

After removing the assembly pin 34, the wedge members 24 move radially to the inside due to the spring force of the spring element 32, so that a circumferential gap 40 is formed, whose radial dimension is designated with d in FIG. 2. Since there are provided at least three wedge members 24 uniformly distributed over the circumference, a radial centering between the wedge member unit 30 and the thrust piece 20 takes place automatically. At the same time, a predeterminable axial pressing force Fₚᵣₑₛₛᵤᵣₑ is obtained via the shell surface of the truncated cone and the inclined surfaces of the wedge members 24 resting against the same. This pressing force Fₚᵣₑₛₛᵤᵣₑ can be adjusted for example via an angle of the shell surface and the inclined surfaces relative to the pressing axis A, a radial spring force of the spring element 32, and the friction values between wedge members 24 and thrust piece 20 or between wedge members 24 and bearing element 22.

To prevent the ingress of dirt into the pressing device 18, an assembly plug 42, for example a rubber plug, is clipped into the assembly opening 38 after removing the assembly pin 34, in order to tightly close the assembly opening 38 in essence.

FIG. 3 shows a cross-section A-A through the pressing device 18 in the state of use at the beginning of the useful life. The circumferential gap 40 ensures that during a steering maneuver a movement of the rack 14 along its rack axis Z is not impeded by the pressing device 18. If during the steering maneuver, for example as a result of manufacturing tolerances in the components of the rack-and-pinion steering system 10, the rack 14 exerts a force F_{ZS} on the pressing device 18 in direction of the pressing axis A, which exceeds the pressing force Fₚᵣₑₛₛᵤᵣₑ of the pressing device 18, the thrust piece 20 can move axially in direction of the bearing element 22 by pushing the wedge members 24 radially to the outside against the spring force of the spring element 32. The radial dimension d of the circumferential gap 40 represents a maximum path of displacement of the wedge members 24. In other words, the housing 12 forms a stop which limits a displacement of the wedge members 24 radially to the outside. Particularly preferably, the spring element 32 is accommodated in a circumferential groove 44 of the wedge members 24 or the wedge member unit 30, so that the wedge members 24 or the wedge member unit 30 radially extend(s) further to the outside than the spring element 32. The spring element 32 thereby is axially fixed, and there is produced less impact noise during the radial movement against the housing 12.

As soon as the force F_{ZS} produced by the rack 14 in direction of the pressing axis A falls below the pressing force Fₚᵣₑₛₛᵤᵣₑ, the spring element 32 again moves the wedge members 24 into their position according to FIG. 3.

FIG. 4 shows a cross-section A-A through the pressing device 18 in the state of use towards the end of the useful life. At this time, an axial dimension of the thrust piece 20 has been reduced due to the wear occurring during the useful life. To ensure that the desired pressing force Fₚᵣₑₛₛᵤᵣₑ is maintained and no axial backlash is produced in the pressing device 18, the wedge members 24 were more and more urged towards each other, i.e. radially to the inside, by the spring element 32 with increasing wear.

As seen radially from the inside to the outside, the wedge members 24 conically flare in axial direction (see FIGS. 1 and 2). In addition, as seen radially from the inside to the outside, the wedge members 24 however also flare in circumferential direction 26 and form segment-shaped wedge members 24 according to FIGS. 3 and 4, in order to reduce the surface pressures and hence also the material stress.

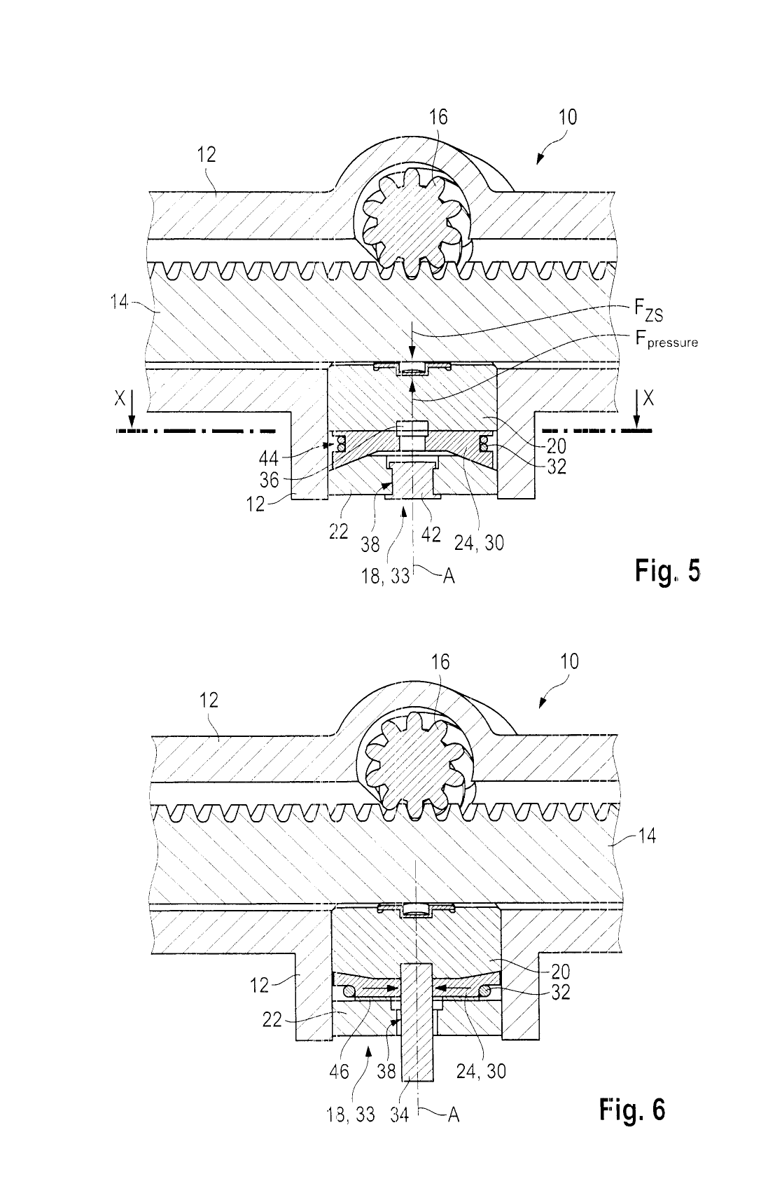

FIGS. 5 to 8 show alternative embodiments of the pressing device 18. However, since in terms of their basic construction and general mode of operation these design variants substantially correspond to the pressing device 18 according to FIGS. 1 to 4, reference is made to the above description and in the following merely the differences of the embodiments will be discussed. Individual features, which were only explained with reference to a special embodiment, can of course also expediently be combined with other embodiments.

FIG. 5 shows a section of the rack-and-pinion steering system 10 with a pressing device 18 which differs from the embodiment according to FIG. 2 merely in that not the thrust piece 20 is formed on a side facing the bearing element 22, but the bearing element 22 is formed as truncated cone on a side facing the thrust piece 20. The wedge member unit 30 correspondingly is reversed.

It is of course also conceivable to combine the embodiments according to FIGS. 2 and 5. In this case, both the thrust piece 20 would be formed on a side facing the bearing element 22 and the bearing element 22 would be formed as truncated cone on a side facing the thrust piece 20. The wedge members 24 then would each have complementary, inclined wedge surfaces on both axial sides.

FIG. 6 shows a section of the rack-and-pinion steering system 10 with an alternative pressing device 18. In contrast to the aforementioned embodiments, the spring element 32 of the pressing device 18 here is formed as O-ring, wherein the O-ring for example is made of a plastic material.

In addition, axially between the bearing element 22 and the thrust piece 20, concretely between the bearing element 22 and the wedge members 24, an element 46 elastic in axial direction is provided. According to FIG. 6, this elastic element 46 is a rubber plate which increases the friction between the wedge members 24 and the bearing element 22. In the case of an overload, i.e. when the force F_{ZS} increases in direction of the pressing axis A beyond the desired pressing force Fₚᵣₑₛₛᵤᵣₑ, a movement of the thrust piece 20 in direction of the bearing element 22 first of all is achieved by an axial compression of the elastic element 46. A displacement of the wedge members 24 relative to the bearing element 22 radially to the outside only is possible to a small extent by a corresponding deformation of the elastic element 46.

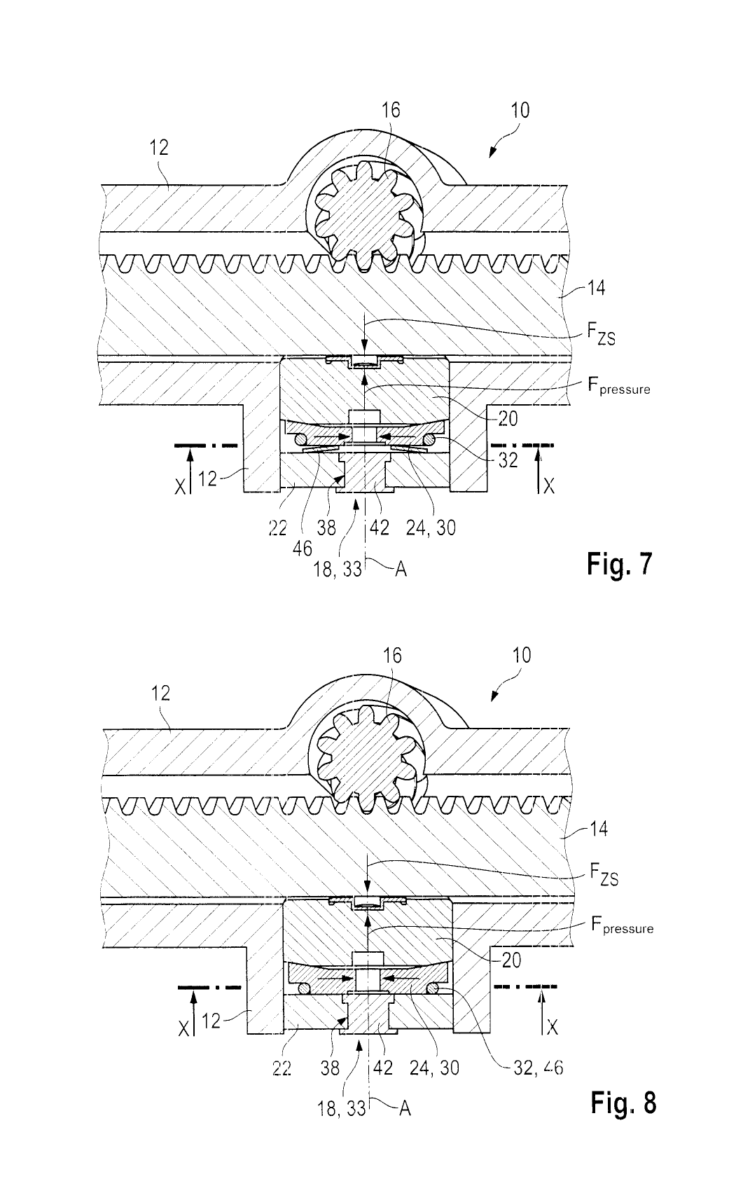

A section of the rack-and-pinion steering system 10 with another alternative pressing device 18 is shown in FIG. 7. The pressing device 18 according to FIG. 7 differs from the embodiment according to FIG. 6 merely in that the elastic element 46 is formed as disk spring. By this disk spring the friction between the thrust pieces 20 and the bearing element 22 is not increased or only to a small extent as compared to the embodiment according to FIG. 2. In a case of overload, an axial movement of the thrust piece 20 in direction of the bearing element 22 hence can occur both due to an axial deformation of the disk spring and due to a radial displacement of the wedge members 24 relative to the bearing element 22.

FIG. 8 shows a section of the rack-and-pinion steering system 10 with another alternative pressing device 18. Analogous to the embodiment according to FIGS. 6 and 7, the spring element 32 is manufactured as O-ring made of plastics, in particular rubber, wherein the O-ring in this case however axially protrudes beyond the wedge members 24, is axially elastic and axially rests on the bearing element 22.

Thus, the spring element 32 formed as O-ring urges the wedge members 24 radially to the inside analogous to the remaining embodiments, in order to provide a largely constant pressing force Fₚᵣₑₛₛᵤᵣₑ and a wear compensation. Since the spring element 32 according to FIG. 8, however, is axially elastic and axially protrudes beyond the wedge members 24, it also assumes the function of the elastic element 46 of the pressing device 18 (cf. FIGS. 6 and 7). Consequently, such elastic element 46 can be omitted.

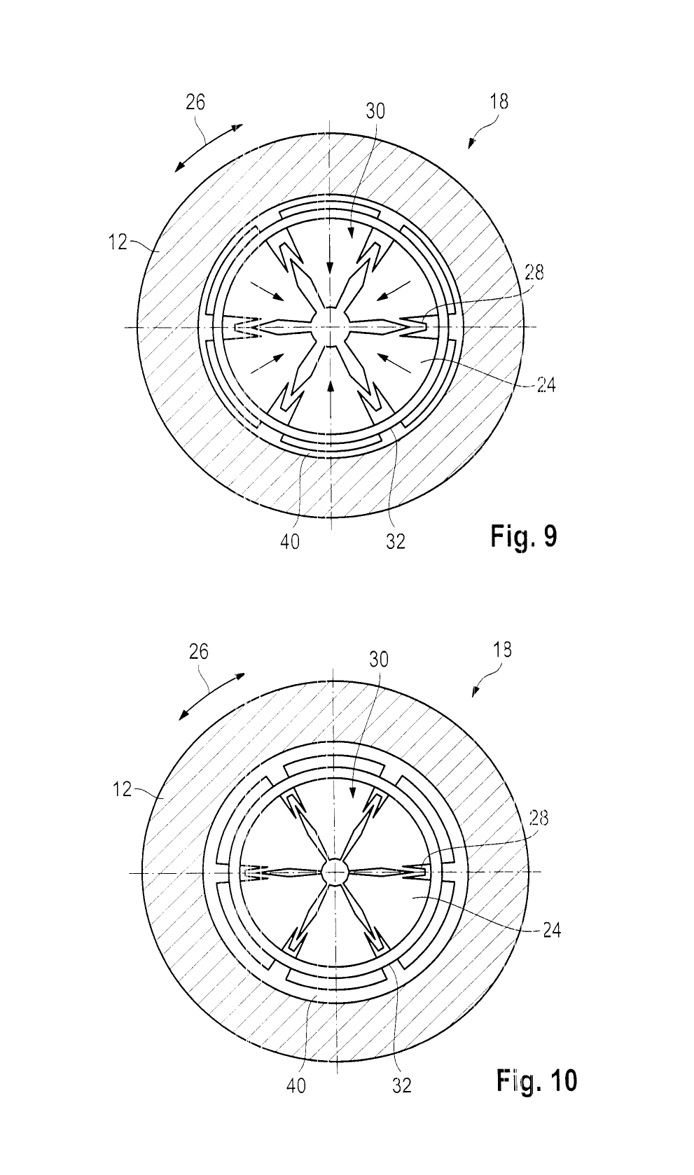

Analogous to FIGS. 3 and 4, FIGS. 9 and 10 show cross-sections A-A through the pressing device 18, wherein the spring element 32 in FIGS. 9 and 10, however, is formed as O-ring made of plastics and not as circlip made of metal.

In accordance with the provisions of the patent statutes, the principle and mode of operation of this invention have been explained and illustrated in its preferred embodiments. However, it must be understood that this invention may be practiced otherwise than as specifically explained and illustrated without departing from its spirit or scope.

1. A device for pressing a rack against a pinion, comprising
a housing,
a thrust piece which is shiftably guided in said housing along a pressing axis,
a bearing element which can axially be fixed at said housing, and
radially pressurized wedge members which each rest on said thrust piece and on said bearing element and axially urge said thrust piece away from said bearing element,
a truncated coned being formed at least on one of said thrust piece on a side facing said bearing element and said bearing element on a side facing said thrust piece, and
at least three wedge members being provided which are uniformly distributed in a circumferential direction.

2. The device of claim 1 wherein said wedge members are made of plastics.

3. The device of claim 1 wherein said wedge members are movable relative to each other.

4. The device of claim 1 wherein a flexible coupling element is provided between two of said wedge members which are adjacent in a circumferential direction.

5. The device of claim 4 wherein said wedge members and said coupling element are formed in one piece.

6. The device of claim 1 wherein an element which is elastic in axial direction, is provided axially between said bearing element and said thrust piece.

7. The device of claim 6 wherein said elastic element is one of a disk spring and a rubber plate.

8. The device of claim 1 wherein a spring element is provided, which pressurizes said wedge members in a direction which is radial with respect to the pressing axis.

9. The device of claim 8 wherein said spring element surrounds said wedge members and urges said wedge member radially inwardly.

10. The device of claim 8 wherein said spring element axially protrudes beyond said wedge members, said spring element being elastic in an axial direction and resting on said bearing element in an axial direction.

11. The device of claim 1 wherein, as seen radially from the inside to the outside, said wedge members flare in a wedge-like manner in an axial direction.

12. A rack-and-pinion steering system for motor vehicles, comprising
a gear housing,
a rack shiftably mounted in said gear housing,
a pinion which engages into said rack, and
a device for pressing said rack against said pinion, comprising
a housing,
a thrust piece which is shiftably guided in said housing along a pressing axis,
a bearing element which can axially be fixed at said housing, and
radially pressurized wedge members which each rest on said thrust piece and on said bearing element and axially urge said thrust piece away from said bearing element,
a truncated coned being formed at least on one of said thrust piece on a side facing said bearing element and said bearing element on a side facing said thrust piece, and
at least three wedge members being provided which are uniformly distributed in a circumferential direction.
